(19) United States
(12) Patent Application Publication
(10) Pub. No.: US 2025/0173838 A1
(43) Pub. Date: May 29, 2025

(54) TEMPORALLY CONSISTENT HUMAN IMAGE ANIMATION METHOD

(71) Applicant: Lemon Inc., Grand Cayman (KY)

(72) Inventors: Zhongcong Xu, Singapore (SG); Jianfeng Zhang, Singapore (SG); Jun Hao Liew, Singapore (SG); Hanshu Yan, Singapore (SG); Chenxu Zhang, Los Angeles, CA (US); Jiashi Feng, Singapore (SG)

(21) Appl. No.: 18/923,549

(22) Filed: Oct. 22, 2024

Related U.S. Application Data
(60) Provisional application No. 63/602,509, filed on Nov. 24, 2023.

(51) Int. Cl. G06T 5/70; G06T 5/60; G06T 7/20

(52) U.S. Cl. CPC G06T 5/70; G06T 5/60; G06T 7/20; G06T 2207/10016; G06T 2207/20084

(57) ABSTRACT

A computing system is described herein that implements a diffusion-based framework for animating reference images. The computing system includes a video diffusion model that is utilized to encode temporal information. The computing system further includes a novel appearance encoder that is utilized to retain the intricate details of the reference image and maintain appearance coherence across frames. The computing system further employs a video fusion technique to smooth transitions between animated segments in long video animation. Potential benefits of the computing system include enhanced temporal consistency, faithful preservation of reference images, and improved animation fidelity in the generated animation sequences.

### CROSS REFERENCE TO RELATED APPLICATIONS

This application claims priority to U.S. Provisional Patent Application Ser. No. 63/602,509, filed Nov. 24, 2023, the entirety of which is hereby incorporated herein by reference for all purposes.

### BACKGROUND

The present disclosure relates to a human image animation task, which aims to generate a video of a certain reference identity following a particular motion sequence. Existing approaches typically employ a frame-warping technique to animate a reference image towards a target motion. However, these approaches face challenges in maintaining temporal consistency throughout the animation due to the lack of temporal modeling and poor preservation of reference identity.

### SUMMARY

To address the above issues, a computing system is provided. In one example, the computing system includes processing circuitry configured to implement an appearance encoder configured to encode a reference image into an appearance embedding. The processing circuitry is further configured to implement a pose control network configured to receive as input a target pose sequence and in response extract a motion condition from the target pose sequence. The processing circuitry is further configured to implement a video diffusion model including a temporal attention mechanism, where the video diffusion model is configured to receive as inputs the appearance embedding and the motion condition, and generate a denoised animation sequence.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows animation produced by the computing systems and methods of the present disclosure, as compared to prior techniques, in response to a sequence of motion signals.

FIG. 2 shows a schematic view of a computing system including processing circuitry configured to implement an appearance encoder, a pose control network, and a trained video diffusion model.

FIG. 3 shows qualitative comparisons between the present disclosure and baselines on Dataset A and Dataset B datasets.

FIGS. 4A and 4B show visualizations of ablation studies with errors highlighted in the white boxes, where each frame has the reference image overlayed at the bottom left corner and the target pose at the bottom right corner.

FIGS. 5A, 5B, and 5C show animation generalization results for unseen domain animation, text-to-image combination, and multi-person animation.

FIGS. 6A and 6B show quantitative comparison results between the present disclosure and baselines on two benchmark datasets.

FIGS. 7A-7E show data gathered during ablations of the present disclosure on the social networking platform dataset.

FIG. 8 shows a flowchart of a computerized method for generating a denoised animation sequence according to the present disclosure.

FIG. 9 shows a schematic view of an example computing environment in which the computing systems and methods described herein may be enacted.

### DETAILED DESCRIPTION

### 1. Introduction

Given a sequence of motion signals such as video, depth, or pose, the image animation task aims to bring static images to life. The animation of humans, animals, cartoons, or other general objects has attracted research attention. Among these, human image animation has been the most extensively explored, given its potential applications across various domains, including social media, movie industry, and entertainment, etc. In contrast to traditional graphic approaches, the abundance of data enables the development of low-cost data-driven animation frameworks.

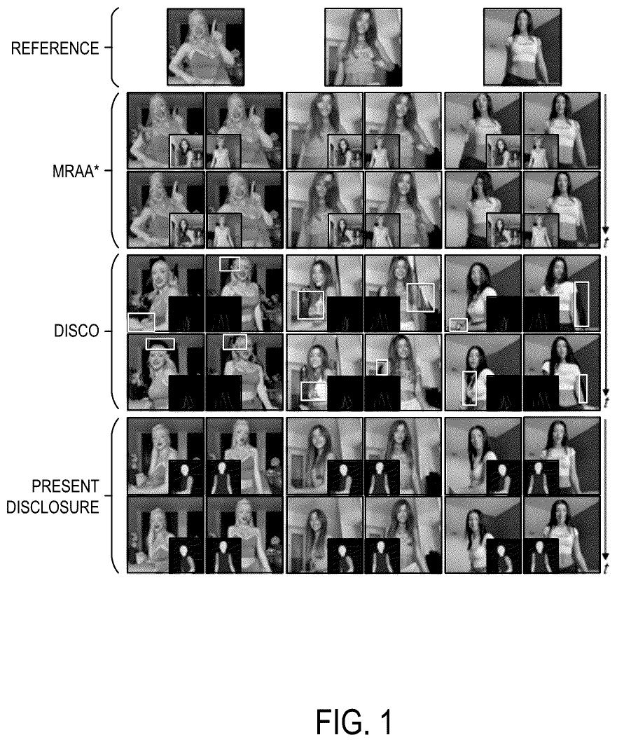

Existing data-driven methods for human image animation can be categorized into two primary groups based on the generative backbone models used, namely GAN-based and diffusion-based frameworks. The former typically employ a warping function to deform the reference image into the target pose and utilize GAN models to extrapolate the missing or occluded body parts. In contrast, the latter harness appearance and pose conditions to generate the target image based on pretrained diffusion models. Despite generating visually plausible animations, these methods typically exhibit several limitations: 1) GAN-based methods possess restricted motion transfer capability, resulting in unrealistic details in occluded regions and limited generalization ability for cross-identity scenarios, as depicted in FIG. 1. 2) Diffusion-based methods, on the other hand, process a lengthy video in a frame-by-frame manner and then stack results along the temporal dimension. Such approaches neglect temporal consistency, resulting in flickering results. In addition, these works typically rely on a technique known as CLIP to encode reference appearance, which is known to be less effective in preserving details, as highlighted in the white boxes in FIG. 1.

To address this challenge, in the present disclosure a computing system is provided that implements a human image animation framework which is a diffusion-based framework, referred to herein as “Animation Program,” which aims to enhance temporal consistency, preserve the reference image faithfully, and improve animation fidelity. First, the computing system includes a video diffusion model that is utilized to encode temporal information. Second, to maintain the appearance coherence across frames, the computing system includes a novel appearance encoder that is utilized to retain the intricate details of the reference image. Leveraging these two innovations, the computing system further employs a video fusion technique to encourage smooth transitions for long video animation. Empirical results demonstrate the superiority of the present systems and methods over baseline approaches on two benchmarks. Notably, the present approach outperforms the strongest baseline by over 38% in terms of video fidelity on the challenging Dataset A dancing dataset.

As demonstrated by the results data discussed below, the present systems and methods can achieve long-range temporal consistency, robust appearance encoding, and high per-frame quality. To achieve these results, a video diffusion model is utilized that encodes temporal information by incorporating temporal attention blocks into the diffusion network. Secondly, an innovative appearance encoder is utilized that preserves the human identity and background information derived from the reference image. Unlike existing works that employ CLIP-encoded visual features, the present appearance encoder is capable of extracting dense visual features to guide the animation, which leads to better preservation of identity, background, clothes, etc. To further improve per-frame fidelity, an image-video joint training strategy is utilized to leverage diverse single-frame image data for augmentation, which provides richer visual cues to improve the modeling capability of the framework for details. Lastly, a video fusion technique is used to enable long video animation with smooth transitions.

The following disclosure describes a novel diffusion-based human image animation approach that integrates temporal consistency modeling, precise appearance encoding, and temporal video fusion, for synthesizing temporally consistent human animation of arbitrary length. State-of-the-art performance is achieved on two benchmarks. Notably, the methods described herein surpass the strongest baseline by more than 38% in terms of video quality on the challenging Dataset A dancing dataset. Further, the methods herein showcase robust generalization ability, being applicable to cross-identity animation and various downstream applications, including unseen domain animation and multi-person animation.

### 2. Related Work

### 2.1 Data-Driven Animation

Prior efforts in image animation have predominantly concentrated on the human body or face, leveraging the abundance of diverse training data and domain-specific knowledge, such as keypoints, semantic parsing, and statistical parametric models. Building upon these motion signals, a long line of work has emerged. These approaches can be classified into two categories based on their animation pipeline, i.e., implicit and explicit animation. Implicit animation methods transform the source image to the target motion signal by deforming the reference image in subexpression space or manipulating the latent space of a generative model. The generative backbone conditions on target motion signal to synthesize animations. Conversely, explicit methods warp the source image to the target by either 2D optical flow, 3D deformation field, or directly swapping the face of target image. In addition to deforming the source image or 3D mesh, recent research efforts explore explicitly deforming points in 3D neural representations for human body and face synthesis, showcasing improved temporal and multi-view consistency.

### 2.2 Diffusion Models for Animation

The remarkable progress in diffusion models has propelled text-to-image generation to unprecedented success, spawning numerous subsequent works, such as controllable image generation and video generation. Recent works have embraced diffusion models for human-centric video generation and animation. Among these works, a common approach develops a diffusion model for generating 2D optical flow and then animates the reference image using frame-warping technique. Moreover, many diffusion-based animation frameworks employ Stable Diffusion as their image generation backbone and leverage ControlNet to condition the animation process on OpenPose keypoint sequences. For the reference image condition, they usually adopt a pretrained image-language model, CLIP, to encode the image into a semantic-level text token space and guide the image generation process through cross-attention. While these works yield visually plausible results, most of them process each video frame independently and neglect the temporal information in animation videos, which inevitably leads to flickering animation results.

### 3. Method of the Subject Disclosure

Given a reference image I_{ref} and a motion sequence p^{1:N}=[p₁, . . . , p_{N}], where N is the number of frames, the objective is to synthesize a continuous video l^{1:N}=[l₁, . . . , l_{N}] with the appearance of I_{ref} while adhering to the provided motion p^{1:N}.

Existing diffusion-based frameworks process each frame independently, neglecting the temporal consistency among different frames, which consequently results in flickering animations. To address this, a video diffusion model FT for temporal modeling is provided with temporal attention blocks incorporated into the diffusion backbone (Sec. 3.1). In addition, existing works use CLIP encoder to encode the reference image. The semantic-level features introduced by the CLIP encoder are believed to be too sparse and compact to capture intricate details. Therefore, herein a novel appearance encoder [symbol] ₐ (Sec. 3.2) is provided to encode I_{ref} into appearance embedding [symbol] ₐ and condition the model for identity- and background-preserving animation.

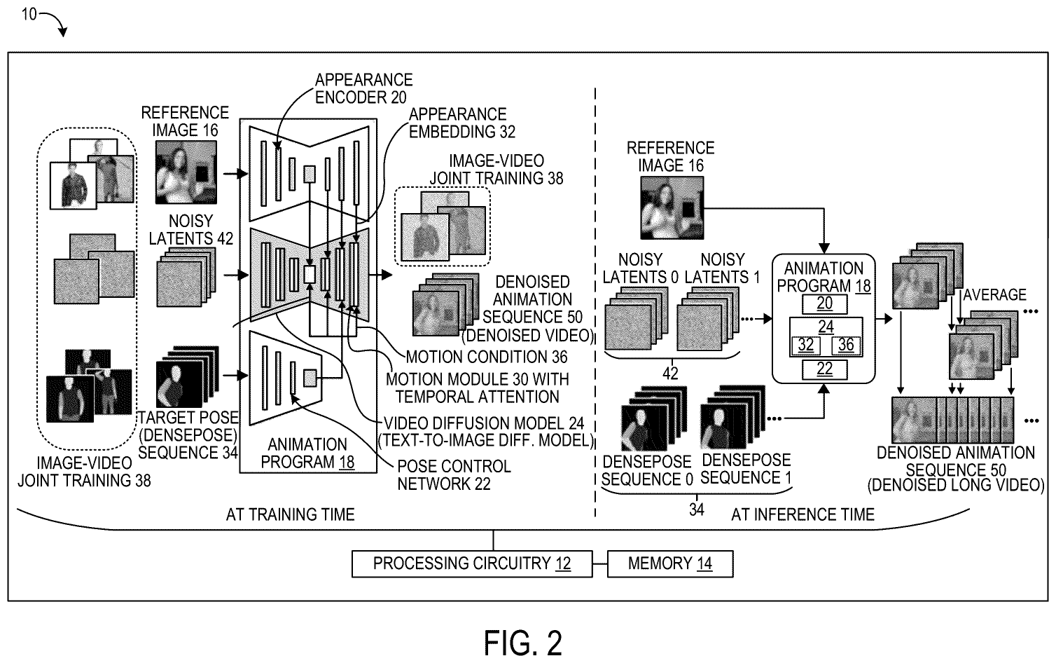

The overall pipeline of the system (Sec. 3.3) of the present disclosure is depicted in FIG. 2. FIG. 2 shows a schematic view of a computing system 10 including processing circuitry 12 configured to execute an animation program 18 that implements an appearance encoder 20, a pose control network 22, and a trained video diffusion model 24 (text-to-image diffusion model). For example, the computing system 10 may include a cloud server platform including a plurality of server devices, and the processing circuitry 12 may be one processor of a single server device, or multiple processors of multiple server devices. The computer system 10 may also include one or more client devices in communication with the server devices, and the processing circuitry 12 may be situated in such a client device.

This figure shows a processing pipeline employed by the computing systems and methods of the present disclosure. Given a reference image 16 and target DensePose motion sequence 34, the computing systems and methods described herein employ a video diffusion model 24 and an appearance encoder 20 for temporal modeling and identity preserving, respectively (left panel). To support long video animation, a video fusion strategy that produces smooth video transition during inference is used (right panel).

First, at training time, the processing circuitry 12 is configured to implement the appearance encoder 20 configured to encode the reference image 16 into an appearance embedding 32, where the reference image 16 is embedded into appearance embedding [symbol] ₐ using the appearance encoder 20. For example, the reference image 16 may include an image of a human. The processing circuitry 12 is further configured to implement the pose control network 22 configured to receive as input the target pose sequence 34 and in response extract a motion condition 36 from the target pose sequence 34, where the target pose sequence 34, i.e., DensePose, is passed into a pose ControlNet [symbol] to extract motion condition [symbol] ^{1:K}. Conditioning on these two signals, the video diffusion model 24 is trained to animate the reference human identity to follow the given motions. In practice, due to memory constraints, the entire video is processed in a segment-by-segment manner.

At an inference time, the processing circuitry 12 is configured to implement the appearance encoder 20 configured to encode the reference image 16 into the appearance embedding 32. The processing circuitry 12 is further configured to implement the pose control network 22 configured to receive as input the target pose sequence 34 and in response extract the motion condition 36 from the target pose sequence 34. The processing circuitry 12 is further configured to implement a trained video diffusion model 24 including a temporal attention mechanism, in which the video diffusion model 24 is configured to receive as inputs the appearance embedding 32 and the motion condition 36, and generate a denoised animation sequence 50.

Thanks to the temporal modeling and robust appearance encoding, the animation program 18 can largely maintain temporal and appearance consistency across segments. Nevertheless, there still exists minor discontinuities between segments. To mitigate this, leveraging a video fusion approach is used to improve the transition smoothness. Specifically, as depicted in FIG. 2, the video animation is generated in multiple overlapping segments where the entire video is decomposed into overlapping segments, and the predictions for overlapping frames are averaged. Lastly, a joint training 38 using image datasets and video datasets is employed at a training time, where an image-video joint training strategy is used to further enhance the reference-preserving capability and single-frame fidelity (Sec. 3.4).

### 3.1 Temporal Consistency Modeling

To ensure temporal consistency across video frames, extend the image diffusion model is extended to the video domain. Specifically, the original 2D UNet is inflated to a 3D temporal UNet by inserting temporal attention layers. The temporal UNet is denoted as [symbol] ^{T}(⋅; θ^{T}) with trainable parameters θ^{T}. The architecture of the inflated UNet blocks is illustrated in FIG. 2. First, randomly initialized latent noise zₜ^{1:K} is generated, where K is the length of the video frames. Then, K consecutive poses are stacked into a DensePose sequence p^{1:K} for motion guidance. The process next inputs zₜ^{1:K} to the video diffusion backbone [symbol] ^{T} by reshaping the input features from [symbol] ^{N×C×K×H×W} into [symbol] ^{(NK)×C×H×W}. Within temporal modules, the features are reshaped into [symbol] ^{(NHW)×K×C} to compute cross-frame information along the temporal dimension.

Transferable motion priors are learned from video data. To learn the motion priors, the video diffusion model 24 includes a pretrained motion module including a transformer that has been trained on successive video frames to predict motion of image features in successive frames. The processing circuitry is further configured to implement a temporal video fusion operation using the pretrained motion module to generate the denoised animation sequence. The pretrained motion module is trained by adding sinusoidal framewise positional encoding to successive frames of a training video to encode a position of each frame within the training video. The pretrained motion module is further trained by training the motion module to predict motion of visual features within the images of successive video frames by using a temporal attention mechanism that computes attention for each element of an image across elements in the successive frames of video using the framewise positional encoding.

Sinusoidal positional encoding is added to make the model aware of the position for each frame within the video. As such, temporal attention is computed using the attention operation,

$$Attention ( Q , K , V ) = Softmax ( \frac{Q {K}^{T}}{\sqrt{d}} ) V ,$$

where Q= [symbol] , K= [symbol] , V= [symbol] . Through this attention mechanism, the animation program 18 aggregates temporal information from neighboring frames and synthesizes K frames with improved temporal consistency, where the denoised animation sequence exhibits temporal consistency.

### 3.2 Appearance Encoder

The goal of human image animation is to generate results under the guidance of a reference image I_{ref}. The core objective of the subject appearance encoder is representing I_{ref} with detailed identity and background-related features that can be injected into the video diffusion model for retargeting under the motion signal guidance. A novel appearance encoder is utilized with improved identity and background preservation to enhance single-frame fidelity and temporal coherence. Specifically, the appearance encoder 20 creates another trainable copy of the base UNet [symbol] (⋅; θ^{a}) and computes the condition features for the reference image I_{ref} for each denoising step t. This process is mathematically formulated as

$${𝓎}_{a} = {ℱ}_{a} ( {𝓏}_{t} \vert {I}_{ref} , t , {θ}^{a} ) , \qquad ( 1 )$$

where [symbol] ₐ is a set of normalized attention hidden states for the middle and upsampling blocks. Different from ControlNet which adds conditions in a residual manner, these features are passed to the spatial self-attention layers in the UNet blocks by concatenating each feature in [symbol] ₐ with the original UNet self-attention hidden states to inject the appearance information. The appearance condition process is mathematically formulated as:

$$Attention ( Q , K , V , {𝓎}_{a} ) = Softmax ( \frac{{{QK}^{′}}^{T}}{\sqrt{d}} ) {V}^{′} , \qquad ( 2 )$$

$$Q = {W}^{Q} {𝓏}_{t} , {K}^{′} = {W}^{K} [ {𝓏}_{t} , {𝓎}_{a} ] , {V}^{′} = {W}^{V} [ {𝓏}_{t} , {𝓎}_{a} ]$$

where [⋅] denotes concatenation operation. Through this operation, motion conditions are concatenated with the pose control net hidden states and passed to spatial self-attention layers of the trained video diffusion model 24, to thereby transfer portions of the reference image 16 to corresponding portions of the target motion sequence. Through this operation, the spatial self-attention mechanism in the video diffusion model can be adapted into a hybrid one. This hybrid attention mechanism can not only maintain the semantic layout of the synthesized image, such as the pose and position of the human in the image, but also query the contents from the reference image 16 in the denoising process to preserve the details, including identity, clothes, accessories, and background. This improved preservation capability benefits the disclosed framework in two aspects: (1) the method can transfer the reference image 16 faithfully to the target motion; and (2) the strong appearance condition contributes to temporal consistency by retaining the same identity, background, and other details throughout the entire video.

### 3.3 Animation Pipeline

With the incorporation of temporal consistency modeling and the appearance encoder 20, these elements are combined with pose conditioning, i.e., ControlNet, to transform the reference image 16 to the target poses.

Motion transfer. ControlNet for OpenPose keypoints is commonly employed for animating reference human images. One challenge with this approach is that the major body keypoints are sparse and not robust to certain motions, such as rotation. Consequently, DensePose is chosen as the motion signal pᵢ for dense and robust pose conditions. A pose ControlNet [symbol] (⋅, θ^{p}) is employed, with the pose condition for frame i computed as

$${𝓎}_{p , i} = {ℱ}_{p} ( {𝓏}_{t} \vert {p}_{i} , t , {θ}^{p} ) , \qquad ( 3 )$$

where [symbol] _{p,i} is a set of condition residuals added to the residuals for the middle and upsampling blocks in the diffusion model. In the pipeline, the motion feature of each pose is concatenated in a DensePose sequence into [symbol] ^{1:k}.

Denoising process. Building upon the appearance condition [symbol] ₐ and motion condition [symbol] ^{1:K}, Animation Program animates the reference image 16 following the DensePose sequence. The noise estimation function ∈θ^{1:K}(⋅) in the denoising process is mathematically formulated as:

$${ϵ}_{θ}^{1 : K} ( {𝓏}_{t}^{1 : K} , t , {I}_{ref} , {p}^{1 : K} ) = {F}^{T} ( {𝓏}_{t}^{1 : K} \vert t , {𝓎}_{a} , {𝓎}_{p}^{1 : K} ) \qquad ( 4 )$$

where θ is the collection of all the trainable parameters, namely θ^{T}, θ^{a}, and θ^{p}.

Long video animation. With the temporal consistency modeling and appearance encoder, temporally consistent human image animation results can be generated for arbitrary lengths via segment-by-segment processing. However, unnatural transitions and inconsistent details across segments may occur because temporal attention blocks cannot model long-range consistency across different segments.

To address this challenge, a sliding window method is employed to improve transition smoothness in the inference stage. In other words, a sliding window technique has been applied to smooth transitions between segments during inference, in which denoised animation sequence is a video animation generated in multiple segments. As shown in FIG. 2, the long motion sequence is divided into multiple segments with temporal overlap, where each segment has a length of K. First, noise z^{1:N} is sampled for the entire video with N frames, and is also partitioned into noise segments with overlap { [symbol] ^{1:K}, [symbol] ^{K-s+1:2K-s}, . . . , [symbol] ^{n(K-s)+1:n(K-s)+K}}, where n=[(N−K)/(K−s)] and s is the overlap stride, with s<K. If (N−K) mod (K−s)≠0, i.e., the last segment size is less than K, for simplicity, it is simply padded with the first few frames to construct a K-frame segment. Besides, it was empirically found that sharing the same initial noise z^{1:K} for all the segments improves video quality. For each denoising timestep t, noise is predicted and ∈_{θ}^{1:K} obtained for each segment, and then merged into ∈_{θ}^{1:N} by averaging overlap frames. When t=0, the final animation video I^{1:N} is obtained.

### 3.4 Training

Learning objectives. A multi-stage training strategy is employed for the animation program 18. In the first stage, the temporal attention layers are temporarily omitted, and the appearance encoder 20 is trained together with the pose control network 22, where the appearance encoder 20 is trained with the pose control network 22, temporally omitting all of attention layers. The loss term of this stage is computed as

$${ℒ}_{1} = {𝔼}_{{z}_{0}} , t , {I}_{ref} , {p}_{i} , ϵ ∼ 𝒩 ( 0 , 1 ) [ {‖ ϵ - {ϵ}_{θ} ‖}_{2}^{2} ] , \qquad ( 5 )$$

where pᵢ is the DensePose of target image Iᵢ. The learnable modules are [symbol] (⋅, θ^{p}) and [symbol] (⋅, θ^{a}). In the second stage, only the temporal attention layers in [symbol] ^{T}(⋅, θ^{T}) are optimized, and the learning objective is formulated as

$${ℒ}_{2} = {E}_{{z}_{0}^{1 : K}} , t , {I}_{ref} , {p}_{i}^{1 : K} , {ϵ}^{1 : K} ∼ ?? ( 0 , 1 ) [ {‖ {ϵ}^{1 : K} - {ϵ}_{θ}^{1 : K} ‖}_{2}^{2} ] . \qquad ( 6 )$$

Image-video joint training. Human video datasets, compared with image datasets, have a much smaller scale and are less diverse in terms of identities, backgrounds, and poses. This restricts the effective learning of reference condition capability of the proposed animation framework. To alleviate this issue, an image-video joint training strategy is employed.

In the first stage when the appearance encoder 20 and pose control network 22 are pretrained, a probability threshold τ₀ is set for sampling the human images from a large-scale image dataset. A random number r˜U(0, 1) is drawn, where U(⋅, ⋅) denotes uniform distribution. If r≤τ₀, the sampled image is used for training. In this case, the conditioning pose pᵢ is estimated from I_{ref}, and the learning objective of the framework becomes reconstruction.

Although the introduction of temporal attention in the second stage helps improve temporal modeling, it was noticed that this leads to degraded per-frame quality. To simultaneously improve temporal coherence and maintain single frame image fidelity, joint training is also employed in this stage. Specifically, two probability thresholds τ₁ and τ₂ are empirically selected, and r˜U(0, 1) is compared with these thresholds. When r≤τ₁, the training data is sampled from the image dataset, and data is sampled from the video dataset otherwise. Based on the different training data, the denoising process in the training stage is formulated as

$${ϵ}_{θ}^{1 : K} = \{ \begin{matrix}{ϵ}_{θ}^{1 : K} ( {𝓏}_{t} , t , {I}_{ref} , {p}_{i} ) , with i = ref , if r \leq {τ}_{1} , \\ {ϵ}_{θ}^{1 : K} ( {𝓏}_{t} , t , {I}_{ref} , {p}_{i} ) , with i \neq ref , if {τ}_{1} \leq r \leq {τ}_{2} , \\ {ϵ}_{θ}^{1 : K} ( {𝓏}_{t}^{1 : K} , t , {I}_{ref} , {p}^{1 : K} ) , if r \leq {τ}_{2}\end{matrix} \qquad ( 7 )$$

### 4. Experiments

The performance of Animation Program was evaluated using two datasets, namely Dataset A and Dataset B. Dataset A comprises 350 dancing videos, while Dataset B includes 1,203 video clips extracted from an online video sharing platform. To ensure a fair comparison with state-of-the art methods, the identical test set as DisCo was utilized for Dataset A evaluation and the official train/test split was adhered to for Dataset B. All datasets underwent the same preprocessing pipeline.

### 4.1. Comparisons

Baselines. A comprehensive comparison was conducted of Animation Program with several state-of-the-art methods for human image animation: (1) MRAA and TPS are state-of-the-art GAN-based animation approaches, which estimate optical flow from driving sequences to warp the source image and then inpaint the occluded regions using GAN models. (2) DisCo is the state-of-the-art diffusion-based animation method that integrates disentangled condition modules for pose, human, and background into a pretrained diffusion model to implement human image animation. (3) An additional baseline was constructed by combining the state-of-the-art image condition method, i.e., IP-Adapter, with the pose control network, which is labeled as IPA+CtrlN. To make a fair comparison, temporal attention blocks were added into this framework and a video version baseline was constructed labeled as IPA+CtrlNV. In addition, MRAA and TPS methods utilize groundtruth videos as driving signals. To ensure fair comparisons, alternative versions for MRAA and TPS were trained using the same driving signal (DensePose) as Animation Program.

Evaluation metrics. Established evaluation metrics employed in prior research were adhered to in making these comparisons. For the Dataset A dataset, both single-frame image quality and video fidelity were evaluated. The metrics used for single-frame quality include L1 error, SSIM, LPIPS, PSNR, and FID. Video fidelity was assessed through FID-FVD and FVD. On the Dataset B dataset, following MRAA L1 error, average keypoint distance (AKD), missing keypoint rate (MKR), and average Euclidean distance (AED) were reported. However, these evaluation metrics are designed for single-frame evaluation and lack perceptual measurement of the animation results. Consequently, FID, FID-VID, and FVD on the Dataset B dataset were also computed to measure the image and video perceptual quality.

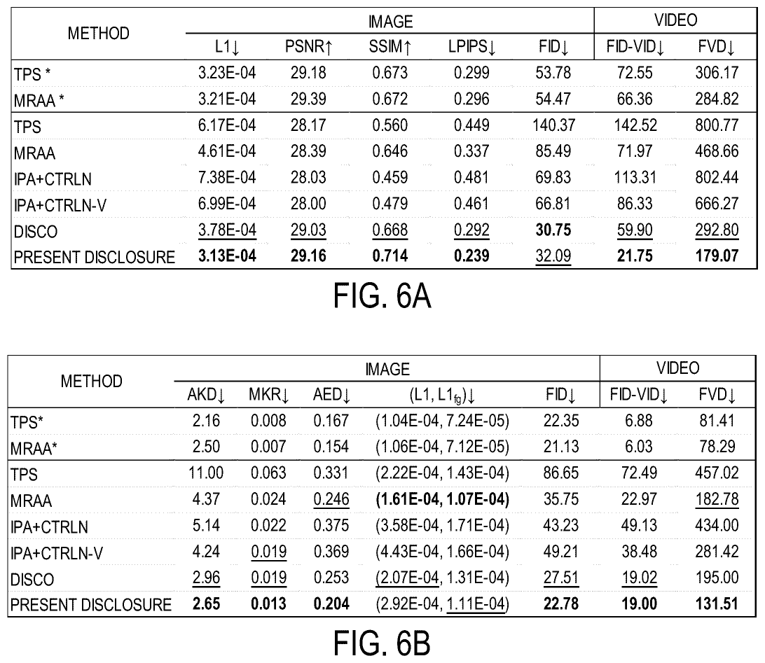

FIGS. 6A and 6B show quantitative comparison results between the present disclosure and baselines on two benchmark datasets, Dataset A and Dataset B. FIGS. 6A and 6B include quantitative comparisons with baselines, with best results in bold and second-best results underlined. The symbol * in the figures indicates that original TPS and MRAA directly use ground-truth video frames for animation, showing the results only for reference. The present method surpasses all baselines in terms of reconstruction metrics, i.e., L1, PSNR, SSIM, and LPIPS, on Dataset A, as shown at FIG. 6A. Notably, the present disclosure improves against the strongest baseline (DisCo) by 6.9% and 18.2% for SSIM and LPIPS, respectively. Additionally, the present disclosure achieves state-of-the-art video fidelity, demonstrating significant performance improvements of 63.7% for FID-VID and 38.8% for FVD compared to DisCo. As shown at FIG. 6B, the present method also exhibits superior video fidelity on Dataset B, achieving the best FID-VID of 19.00 and FVD of 131.51. This performance is particularly notable against the second-best method (MRAA), with an improvement of 28.1% for FVD. Additionally, the present disclosure demonstrates state-of-the-art single-frame fidelity, securing the best FID score of 22.78. Compared with DisCo, a diffusion-based baseline method, the present disclosure showcases a significant improvement of 17.2%. However, it is important to note that the present disclosure has a higher L1 error compared to baselines. This is likely caused by the lack of background information in the DensePose control signals. Consequently, the present disclosure is unable to learn a consistent dynamic background as presented in the TED talks dataset, leading to an increased L1 error. Nevertheless, the present disclosure achieves a comparable L1 error with the strongest baseline (MRAA) in foreground human regions, demonstrating its effectiveness for human animations. Furthermore, the present method achieves the best performance for AKD, MKR, and AED, providing evidence of its superior identity-preserving ability and animation precision.

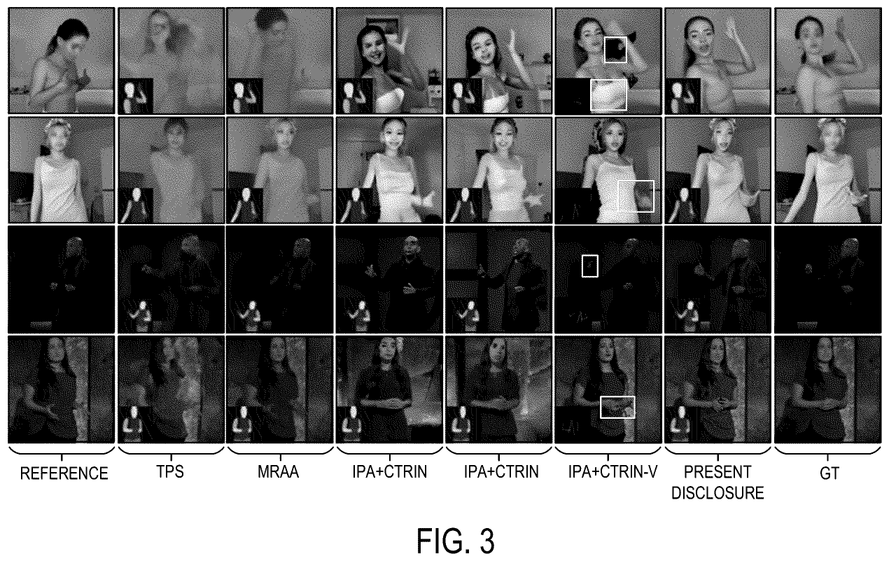

FIG. 3 shows qualitative comparisons between the present disclosure and baselines on Dataset A and Dataset B datasets. The target pose is overlaid on the bottom left corner of the synthesized frames and the artifacts generated by the strongest baseline (DisCo) are highlighted in the white boxes. Notably, the dancing videos from Dataset A exhibit significant pose variations, posing a challenge for GAN based methods such as MRAA and TPS, as they struggle to produce reasonable results when there is a substantial pose difference between the reference image 16 and the driving signal. In contrast, the diffusion-based baselines, IPA+CtrlN, IPA+CtrlN-V, and DisCo, show better single-frame quality. However, as IPA+CtrlN and DisCo generate each frame independently, their temporal consistency is unsatisfactory, as evidenced by the color change of the clothes and inconsistent backgrounds in the occluded regions. The video diffusion baseline, IPA+CtrlN-V, displays more consistent content, yet its single-frame quality is inferior due to weak reference conditioning. Conversely, the present disclosure produces temporally consistent animations and high-fidelity details for the background, clothes, face, and hands.

Unlike Dataset A, Dataset B comprises speech videos recorded under dim lighting conditions. The motions in the Dataset B dataset primarily involve gestures, which are less challenging than dancing videos. Thus, MRAA and TPS produce more visually plausible results, albeit with inaccurate motion. In contrast, IPA+CtrlN, IPA+CtrlN-V, DisCo, and the present disclosure demonstrate a more precise body pose control ability because these methods extract appearance conditions from the reference image to guide the animation instead of directly warping the source image. Among all these methods, the present disclosure exhibits superior identity- and background-preserving ability, as shown in FIG. 3, thanks to the appearance encoder 20 of the present system, which extracts detailed information from reference image.

Cross-identity animation. Beyond animating each identity with its corresponding motion sequence, the cross-identity animation capability of the present disclosure and the state-of-the-art baselines, i.e., DisCo, and MRAA was investigated. Specifically, two DensePose motion sequences were sampled from the Dataset A test set and these sequences were used to animate reference images from other videos. FIG. 1 shows animation produced by the computing systems and methods of the present disclosure, as compared to prior techniques, in response to a sequence of motion signals. The systems and methods described herein produce temporally consistent animation for reference identity images, whereas state-of-the-art methods fail to generalize or preserve the reference appearance, as highlighted in the white boxes in the figure. In the figure, the motion sequence is overlaid at the corner. Note that MRAA directly uses video frames as the driving signal. FIG. 1 illustrates that MRAA fails to generalize for driving videos that contain substantial pose differences, while DisCo struggles to preserve the details in the reference images, resulting in artifacts in the background and clothing. In contrast, the present method faithfully animates the reference images given the target motion, demonstrating its robustness.

### 4.2. Ablation Studies

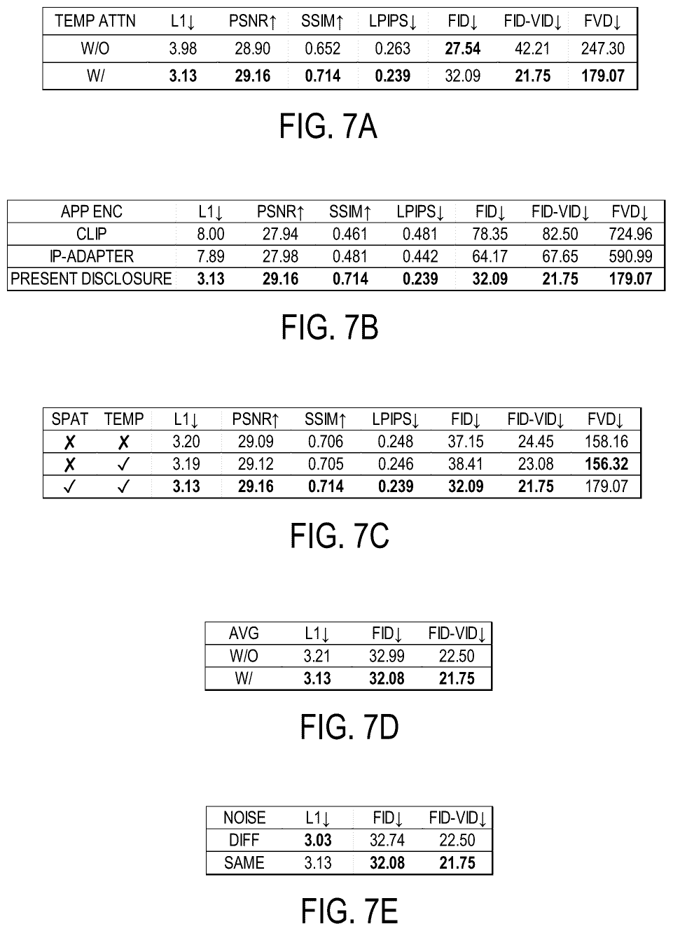

FIGS. 7A-7E show data gathered during ablations of the present disclosure on the Dataset A dataset, with best results in bold. The architectural designs and training strategies were varied to investigate their effectiveness. Specifically, FIG. 7A shows the effect of modeling temporal information. FIG. 7B shows the effect of appearance encoder 20. FIG. 7C shows the effect of image-video joint training. FIG. 7D shows the effect of the inference-stage temporal video fusion. FIG. 7E shows the effect of sharing the same initial noises for all the video segments. FIGS. 7A-7E report L1×10⁻⁴ for numerical simplicity. To verify the effectiveness of the design choices in the present disclosure, ablative experiments were conducted on the Dataset A dataset, which features significant pose variations, a wide range of identities, and diverse backgrounds.

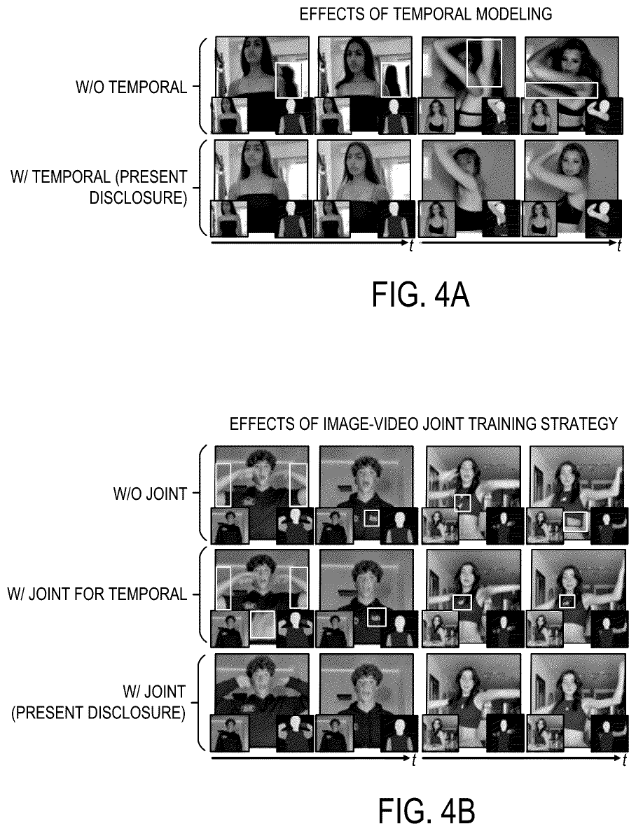

Temporal modeling. To assess the impact of the proposed temporal attention layer, a version of the present disclosure was trained without the temporal attention layer for comparison. The results presented at FIG. 7A show a decrease in both single-frame quality and video fidelity evaluation metrics when the temporal attention layers are discarded, highlighting the effectiveness of the temporal modeling of the present method. This is further supported by the qualitative ablation results presented in FIG. 4A, where the model without explicitly temporal modeling fails to maintain temporal coherence for both humans and backgrounds.

Appearance encoder. To evaluate the enhancement brought by the proposed appearance encoding strategy, the appearance encoder in the present disclosure was replaced with CLIP and IP-Adapter to establish baselines. FIG. 7B summarizes the ablative results. It is evident that the present method significantly outperforms these two baselines in reference image preserving, resulting in a substantial improvement for both single-frame and video fidelity.

Inference-stage video fusion. the present disclosure utilizes a video fusion technique to enhance the transition smoothness of long-term animation. FIG. 7D and FIG. 7E demonstrate the effectiveness of the design choices in the present system and method. In general, skipping the video fusion or using different initial random noises for different video segments diminishes animation performance, as evidenced by the performance drop for both appearance and video quality.

Image-video joint training. An image-video joint training strategy was introduced to enhance the animation quality. As shown in FIG. 7C, applying image-video joint training at both the appearance encoding and temporal modeling stages consistently increases the animation quality. Such improvements can also be observed in FIG. 4B. Without the joint training strategy, the model struggles to model intricate details accurately, tending to produce incorrect clothes and accessories as shown in FIG. 4B.

### 4.3. Applications

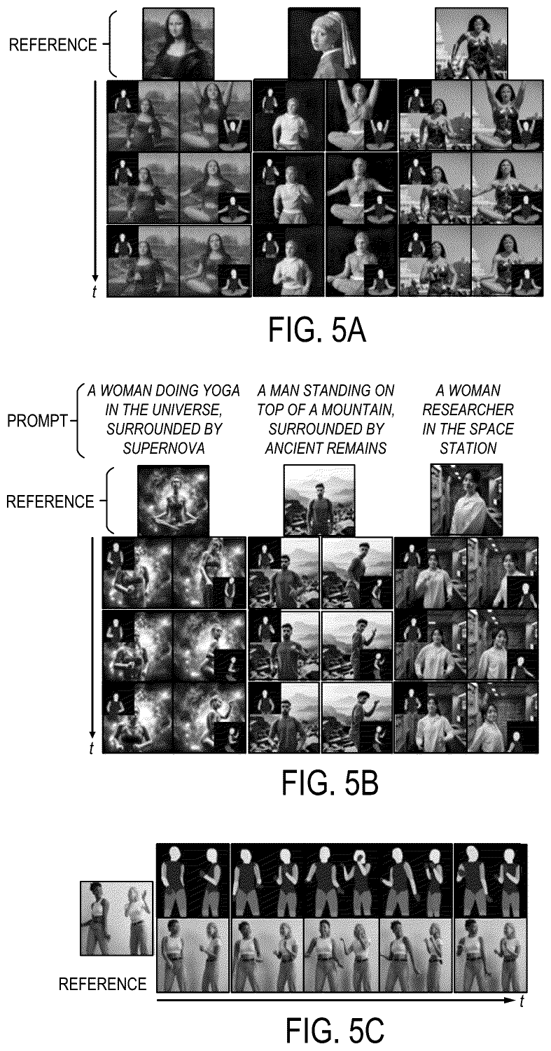

Despite being trained only on realistic human data, the present disclosure demonstrates the ability to generalize to various application scenarios, including animating unseen domain data, integration with a text-to-image diffusion model, and multi-person animation. FIGS. 5A, 5B, and 5C show animation generalization results for unseen domain animation, text-to-image combination, and multi-person animation. FIG. 5A shows animation results for the unseen domain. FIG. 5B shows combining the present disclosure with DALL·E3. FIG. 5C shows multi-person animation. The motion signal is overlayed at the corner of each frame in FIGS. 5A and 5B.

Unseen domain animation, the present disclosure showcases generalization ability for unseen image styles and motion sequences. As shown in FIG. 5A, the present method can animate oil paintings and movie images to perform actions such as running and Yoga, maintaining a stable background and inpainting the occluded regions with temporally consistent results.

Combining text-to-image generation. Due to its strong generalization ability, the present disclosure can be used to animate images generated by text-to-image (T2I) models, e.g., DALL·E3. As shown in FIG. 5B, first DALL·E3 is employed to synthesize the reference image using various prompts. These reference images can then be animated by our model to perform various actions.

Multi-person animation, the present disclosure also exhibits strong generalization for multi-person animation. As illustrated in FIG. 5C, animations can be generated for multiple individuals given the reference frame and a motion sequence, which includes two dancing individuals.

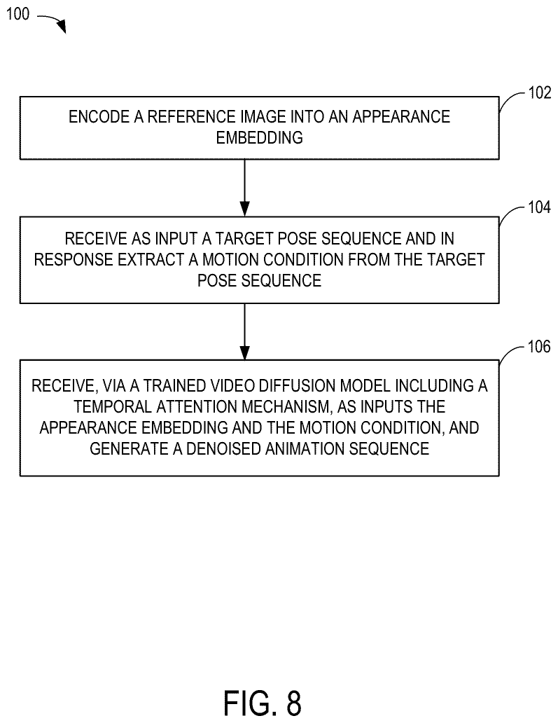

FIG. 8 shows a flowchart of a computerized method 100 for generating a denoised animation sequence according to the present disclosure. The method 100 may be implemented by the computing system 10 illustrated in FIG. 2. At 102, the method 100 may include encoding a reference image into an appearance embedding. At 104, the method 100 may further include receiving as input a target pose sequence and in response extract a motion condition from the target pose sequence. At 106, the method 100 may further include receiving, via a trained video diffusion model including a temporal attention mechanism, as inputs the appearance embedding and the motion condition, and generating a denoised animation sequence.

The present disclosure describes a computing system and method referred to as Animation Program, which is a novel diffusion based framework designed for human avatar animation with an emphasis on temporal consistency. By effectively modeling temporal information, the present disclosure enhances the overall temporal coherence of the animation results. The proposed appearance encoder not only elevates single-frame quality but also contributes to improved temporal consistency. Additionally, the integration of a video frame fusion technique enables seamless transitions across the animation video. The present disclosure demonstrates state-of-the-art performance in terms of both single-frame and video quality. Moreover, its robust generalization capabilities make it applicable to unseen domains and multi-person animation scenarios.

In some embodiments, the methods and processes described herein may be tied to a computing system of one or more computing devices. In particular, such methods and processes may be implemented as a computer-application program or service, an application-programming interface (API), a library, and/or other computer-program product.

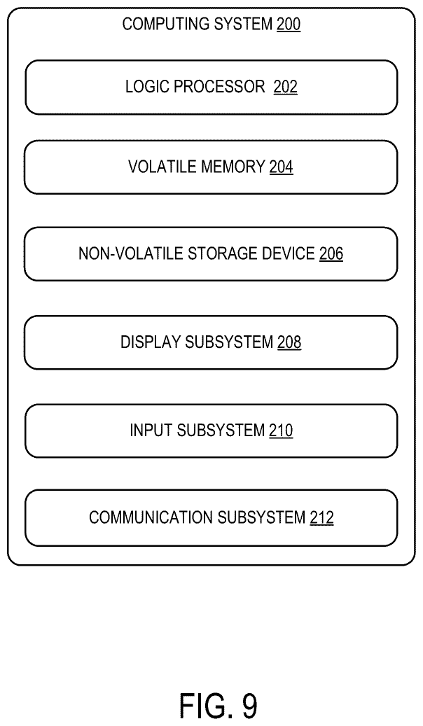

FIG. 9 schematically shows a non-limiting embodiment of a computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 202, input subsystem 210, communication subsystem 212, and/or other components not shown in FIG. 9.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built-in. Non-volatile storage device 206 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; and/or any other suitable sensor.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 200 to send and/or receive messages to and/or from other devices via a network such as the Internet.

The following paragraphs provide additional description of the subject matter of the present disclosure. One aspect provides a computer system comprising processing circuitry configured to implement an appearance encoder configured to encode a reference image into an appearance embedding. The processing circuitry is further configured to implement a pose control network configured to receive as input a target pose sequence and in response extract a motion condition from the target pose sequence. The processing circuitry is further configured to implement a trained video diffusion model including a temporal attention mechanism, the video diffusion model being configured to receive as inputs the appearance embedding and the motion condition, and generate a denoised animation sequence.

In this aspect, the video diffusion model includes a pretrained motion module including a transformer that has been trained on successive video frames to predict motion of image features in successive frames, and the processing circuitry is further configured to implement a temporal video fusion operation using the pretrained motion module to generate the denoised animation sequence.

In this aspect, the pretrained motion module is trained by adding sinusoidal framewise positional encoding to successive frames of a training video to encode a position of each frame within the training video. The pretrained motion module is further trained by training the motion module to predict motion of visual features within the images of successive video frames by using a temporal attention mechanism that computes attention for each element of an image across elements in the successive frames of video using the framewise positional encoding.

In this aspect, denoised animation sequence is a video animation generated in multiple segments, and a sliding window technique has been applied to smooth transitions between segments during inference.

In this aspect, the video animation is generated in multiple overlapping segments, and predictions for overlapping frames are averaged.

In this aspect, the reference image includes an image of a human.

In this aspect, motion conditions are concatenated with the pose control net hidden states and passed to spatial self-attention layers of the trained video diffusion model, to thereby transfer portions of the reference image to corresponding portions of the target motion sequence.

In this aspect, the denoised animation sequence exhibits temporal consistency.

In this aspect, at a training time, the appearance encoder is trained with the pose control network, temporally omitting all of attention layers.

In this aspect, a joint training using image datasets and video datasets is employed at a training time.

Another aspect provides a computerized method including encoding a reference image into an appearance embedding. The method further comprises receiving as input a target pose sequence and in response extract a motion condition from the target pose sequence. The method further comprises receiving, via a trained video diffusion model including a temporal attention mechanism, as inputs the appearance embedding and the motion condition, and generating a denoised animation sequence.

In this aspect, the video diffusion model includes a pretrained motion module including a transformer that has been trained on successive video frames to predict motion of image features in successive frames, and the computerized method further comprises implementing a temporal video fusion operation using the pretrained motion module to generate the denoised animation sequence.

In this aspect, the pretrained motion module is trained by adding sinusoidal framewise positional encoding to successive frames of a training video to encode a position of each frame within the training video. The pretrained motion module is further trained by training the motion module to predict motion of visual features within the images of successive video frames by using a temporal attention mechanism that computes attention for each element of an image across elements in the successive frames of video using the framewise positional encoding.

In this aspect, denoised animation sequence is a video animation generated in multiple segments, and a sliding window technique has been applied to smooth transitions between segments during inference.

In this aspect, the video animation is generated in multiple overlapping segments, and predictions for overlapping frames are averaged.

In this aspect, the reference image includes an image of a human.

In this aspect, motion conditions are concatenated with the pose control net hidden states and passed to spatial self-attention layers of the trained video diffusion model, to thereby transfer portions of the reference image to corresponding portions of the target motion sequence.

In this aspect, the denoised animation sequence exhibits temporal consistency.

In this aspect, at a training time, the appearance encoder is trained with the pose control network, temporally omitting all of attention layers.

Another aspect provides a non-transitory computer readable storage medium storing computer-executable instructions. When executed by processing circuitry, the computer-executable instructions cause the processing circuitry configured to encode a reference image into an appearance embedding. The processing circuitry is further configured to receive as input a target pose sequence and in response extract a motion condition from the target pose sequence. The processing circuitry is further configured to receive, via a trained video diffusion model including a temporal attention mechanism, as inputs the appearance embedding and the motion condition, and generate a denoised animation sequence.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry configured to implement:
an appearance encoder configured to encode a reference image into an appearance embedding;
a pose control network configured to receive as input a target pose sequence and in response extract a motion condition from the target pose sequence; and
a trained video diffusion model including a temporal attention mechanism, the video diffusion model being configured to receive as inputs the appearance embedding and the motion condition, and generate a denoised animation sequence.

2. The computing system of claim 1, wherein
the video diffusion model includes a pretrained motion module including a transformer that has been trained on successive video frames to predict motion of image features in successive frames, and
the processing circuitry is further configured to implement a temporal video fusion operation using the pretrained motion module to generate the denoised animation sequence.

3. The computing system of claim 2, wherein
the pretrained motion module is trained by:
adding sinusoidal framewise positional encoding to successive frames of a training video to encode a position of each frame within the training video; and
training the motion module to predict motion of visual features within the images of successive video frames by using a temporal attention mechanism that computes attention for each element of an image across elements in the successive frames of video using the framewise positional encoding.

4. The computing system of claim 1, wherein
denoised animation sequence is a video animation generated in multiple segments, and
a sliding window technique has been applied to smooth transitions between segments during inference.

5. The computing system of claim 4, wherein
the video animation is generated in multiple overlapping segments, and predictions for overlapping frames are averaged.

6. The computing system of claim 1, wherein the reference image includes an image of a human.

7. The computing system of claim 1, wherein motion conditions are concatenated with the pose control net hidden states and passed to spatial self-attention layers of the trained video diffusion model, to thereby transfer portions of the reference image to corresponding portions of the target motion sequence.

8. The computing system of claim 1, wherein the denoised animation sequence exhibits temporal consistency.

9. The computing system of claim 1, wherein, at a training time, the appearance encoder is trained with the pose control network, temporally omitting all of attention layers.

10. The computing system of claim 1, wherein a joint training using image datasets and video datasets is employed at a training time.

11. A computerized method, comprising:
encoding a reference image into an appearance embedding;
receiving as input a target pose sequence and in response extract a motion condition from the target pose sequence; and
receiving, via a trained video diffusion model including a temporal attention mechanism, as inputs the appearance embedding and the motion condition, and generating a denoised animation sequence.

12. The computerized method of claim 11, wherein
the video diffusion model includes a pretrained motion module including a transformer that has been trained on successive video frames to predict motion of image features in successive frames, and
the computerized method further comprises implementing a temporal video fusion operation using the pretrained motion module to generate the denoised animation sequence.

13. The computerized method of claim 12, wherein
the pretrained motion module is trained by:
adding sinusoidal framewise positional encoding to successive frames of a training video to encode a position of each frame within the training video; and
training the motion module to predict motion of visual features within the images of successive video frames by using a temporal attention mechanism that computes attention for each element of an image across elements in the successive frames of video using the framewise positional encoding.

14. The computerized method of claim 11, wherein
denoised animation sequence is a video animation generated in multiple segments, and
a sliding window technique has been applied to smooth transitions between segments during inference.

15. The computerized method of claim 11, wherein
the video animation is generated in multiple overlapping segments, and predictions for overlapping frames are averaged.

16. The computerized method of claim 11, wherein the reference image includes an image of a human.

17. The computerized method of claim 11, wherein motion conditions are concatenated with the pose control net hidden states and passed to spatial self-attention layers of the trained video diffusion model, to thereby transfer portions of the reference image to corresponding portions of the target motion sequence.

18. The computerized method of claim 11, wherein the denoised animation sequence exhibits temporal consistency.

19. The computerized method of claim 11, wherein, at a training time, the appearance encoder is trained with the pose control network, temporally omitting all of attention layers.

20. A non-transitory computer readable storage medium storing computer-executable instructions, wherein
when executed by processing circuitry, the computer-executable instructions cause the processing circuitry configured to:
encode a reference image into an appearance embedding;
receive as input a target pose sequence and in response extract a motion condition from the target pose sequence; and
receive, via a trained video diffusion model including a temporal attention mechanism, as inputs the appearance embedding and the motion condition, and generate a denoised animation sequence.
